(19) United States
(12) Patent Application Publication
(10) Pub. No.: US 2026/0319700 A1
(43) Pub. Date: Oct. 15, 2026

(54) HOST SYSTEM USING AN ARRAY PAIR TO ACCESS A NON-VOLATILE MEMORY DEVICE

(71) Applicant: Micron Technology, Inc., Boise, ID (US)

(72) Inventor: Pierre Labat, Campbell, CA (US)

(21) Appl. No.: 19/175,454

(22) Filed: Apr. 10, 2025

(51) Int. Cl. G06F 3/06

(52) U.S. Cl. CPC G06F 3/0659; G06F 3/0604; G06F 3/0688

(57) ABSTRACT

Systems, methods, and apparatus related to host system access to a memory sub-system. In one approach, a host system allocates memory for an array pair that includes a send array and completion array. Corresponding slots of the send array and completion array can be randomly accessed using indexes. Threads running on the host system write commands to the send array at slots identified by the indexes. The host system writes the indexes to a doorbell register of the memory sub-system, which retrieves and executes the commands from the send array. Completion records are sent to corresponding slots of the completion array identified using the indexes.

### TECHNICAL FIELD

At least some embodiments disclosed herein relate to memory systems in general, and more particularly, but not limited to providing host system access to a non-volatile memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows an array pair used by a host system to access a solid-state drive according to one embodiment.

FIG. 3 shows an array pair allocated to a cache according to one embodiment.

FIG. 4 shows a host system that writes a slot index to a doorbell register according to one embodiment.

FIG. 5 shows a configuration of completion records generated for sending to a completion queue.

FIG. 6 shows a configuration of completion records generated for sending to a completion array according to one embodiment.

FIG. 7 shows different offsets used to write slot indexes into a doorbell register according to one embodiment.

FIG. 8 shows multiple solid-state drives that share an array pair according to one embodiment.

FIG. 9 shows combining of multiple writes of slot indexes into a single transaction layer packet (TLP) according to one embodiment.

FIG. 10 shows striping of cache pages across multiple solid-state drives according to one embodiment.

FIG. 11 shows thread scheduling for a streaming multiprocessor according to one embodiment.

FIG. 12 shows a method for associating an array pair with one or more memory sub-systems according to one embodiment.

FIG. 13 is a block diagram of an example computer system in which embodiments of the present disclosure can operate.

### DETAILED DESCRIPTION

At least some aspects of the present disclosure are directed to techniques for sending commands from a host system to a memory sub-system. In some embodiments, the commands are sent from a host system to a memory sub-system via a send array. The send array can reside in memory of the host system or in memory of the memory sub-system. Commands can be accessed randomly in the send array using an index.

For example, a storage space in the memory sub-system is accessed by the host system using the commands sent via the send array. For example, the commands can specify read or write operations that access the storage space implemented using one or more non-volatile memory devices of the memory sub-system. The commands retrieved from the send array can be loaded to an internal command queue of the memory sub-system for a controller to execute the commands, including parsing the commands to identify the parameters and options or requirements related to the performing of the read or write operations in the storage space.

The commands sent from the host system can be configured in various ways. In some embodiments, each command is constructed according to a standard of NVMe to have predefined fields and a common total size (e.g., 64 bytes used for each command). In some embodiments, an indication is included in each command to indicate a type of operations to be performed by the memory sub-system during execution of the command. In some embodiments, the commands each have a same total size (e.g., 64 bytes) according to an NVMe standard. For example, a command having 64 bytes can be seen as bit segments arranged as Dwords (double words) 0-15.

A conventional memory sub-system (e.g., a solid-state drive in compliance with a non-volatile memory express (NVMe) standard) can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

A conventional NVMe solid-state drive (SSD) can receive commands from a host system via a submission queue and provide completion records about execution of the commands in a completion queue (sometimes referred to as a queue pair (QP)). The host can write to a doorbell register in the SSD to cause the SSD to poll submission queues for commands.

In a typical NVMe implementation, processors (e.g., CPU, GPU, AI accelerators) communicate over a PCIe bus with an SSD via random access memory/main memory of the host system of the SSD. For example, a pair of message queues in the memory can be used for a processor to send commands to the SSD in the submission queue, and for the SSD to send completion records to the processor in the completion queue.

Each submission queue is a circular queue having slots of the same size. Each slot in a submission queue holds one command for execution by the SSD. Each slot in the completion queue holds a completion record about the execution of a command.

For example, when a submission queue is configured in the host memory outside of the SSD and when a processor enters a command in a submission queue configured in the main memory, all related activity occurs within the host system (e.g., the processor and its main memory/random access memory). The SSD is not aware that the processor has entered the command in the submission queue. The SSD may periodically read the submission queue to determine if there are new commands in the submission queue. Alternatively, that SSD may have a doorbell register; and the processor can write to the doorbell register to cause the SSD to check the submission queue.

In the NVMe standard, the SSD typically reads/writes data in blocks of 512 bytes or more (4 KB is recommended). The NVMe protocol implements certain features for communications between processors and the SSD using access to random access memory. An NVMe command can include various information about operations to be performed (e.g., read or write), a location in a storage space in the SSD for performing the operation, a location in the main memory to store the retrieved data for a read, or a location in the main memory to retrieve the data to be written into the SSD.

With the advent of artificial intelligence (AI), the set of various requirements for storage have become more uncertain as many parts of the AI pipeline now require significantly different IO profiles from prior profiles used for the storage stack. For example, the entire preparation process for data processing can bring large amounts of data close to where the AI training nodes are located. This increases SSD capacity. In a similar way, both AI training and inference nodes can use faster SSDs placed in close proximity to the GPU clusters (or even inside the clusters, in some cases). This creates a new set of requirements for SSDs. To meet these challenges, significant changes can be made in how the CPU/GPU communicates to the storage devices (e.g., SSD in this case).

Within a class of applications (e.g., using CPU/GPU attached SSD to address both AI training and inference needs), there are two areas needing improvement: parallelism and command delivery.

Regarding parallelism, the threading level of a GPU can be massive and use many SSD queue pairs (QPs), as they are the means to convey thread data to the SSD. For example, current SSDs support up to 2K queues, but a typical GPU can have tens of thousands of threads to match. Enqueueing/dequeuing at an N:1 ratio is resource expensive as each insert/remove requires the thread to arbitrate for a lock, acquire the lock, add/remove the entry, release the lock, and then repeat, thus wasting valuable resources and time. The foregoing situation creates the need for the SSD to support a larger number of QPs or potentially even an interface not using QPs (or in a different form from that defined in the NVMe specification).

Regarding command delivery, the NVMe protocol uses a queuing system that is fast but was not designed for the above scale of operation. Even though the queuing system is flexible and widely adopted, there is a need for an improved queue delivery mechanism.

In addition to the above, there are other technical challenges associated with NVMe devices. As SSDs have increased in speed, more recent systems use an SSD as secondary memory in AI applications. For example, many GPU cores/threads may have parallel requests to the SSD for such applications. It can be advantageous to use one queue pair (a pair of submission queue and completion queue) for each thread. However, AI applications in some cases can have a very large number of parallel threads (e.g., hundreds of thousands or more). But, for example, a typical SSD is limited to handling only 1024 submission queues (e.g., because of the hardware/controller used in the SSD). As a result, the host needs to run software to combine commands from multiple threads into a single submission queue. This can cause inefficiencies due to synchronization required for handling the combination of commands from these threads.

In one example, an NVMe interface is used for communication between a GPU or other host on one side of a connection fabric (e.g., PCIe fabric) and an NVMe SSD on the other side of the connection fabric. This interface is used by the GPU or host to send NVMe commands to the SSD and to receive NVMe command completions.

For example, the NVMe interface passes NVMe commands and gets completions as described in NVMe spec 2.0. This interface uses NVMe Submission Queues, Completion Queues, and NVMe doorbells. This interface was designed for use cases in which the number of threads is fairly limited. However, as mentioned above, new use cases having large numbers of threads are emerging for which this interface is not efficient. Thus, there is a need for an improved NVMe interface to cope more efficiently with these new use cases.

In one example of a NVMe use case, threads running in a host operating system (OS) issue NVMe commands. These OS threads (e.g., several thousands of threads) are factored on host logical CPUs (sometimes referred to herein as LCPUs) with one queue pair (QP) associated to each logical CPU. This is done because OS threads are scheduled one at a time on an LCPU.

Even if there are thousands or more OS threads doing input/output operations (IOs) on a host server, only a few hundred (number of host LCPUs) actually access QPs at the same time. This limitation exists because at any given time, only one thread can run on a given LCPU.

Because the QP associated to the LCPU is updated by one thread at a time (the one currently running on the LCPU), there is no need for synchronization between threads regarding QP updates. However, the QP update is typically enclosed by synchronization code to handle the rare situation of one or more LCPUs being removed. This synchronization code doesn't generate significant overhead.

The synchronization is typically implemented via an atomic variable, one per QP. A test-and-set operation is done on that atomic variable. For example, the atomic variable AVi for QPi stays in the L1 cache of LCPUi associated to QPi. A thread running on LCPUj accesses only AVj and never AVi. Consequently, the atomic variable stays exclusive in the L1 cache, and modifying the atomic variable requires about one clock cycle.

An NVMe Completion Queue of a QP is polled by only one thread at a time, running on the LCPU associated to the QP. Hence, the most likely situation for the submission queue (SQ) is that there is no need of synchronization. For this use case, the NVMe interface typically operates satisfactorily.

However, as mentioned above, there are new emerging NVMe use cases in which a processor (e.g., a GPU) issues a large number of NVMe commands. For example, in these use cases hundreds of thousands of GPU threads can access the NVMe QPs simultaneously. This is significantly more than the number of threads for the few hundreds of LCPUs of the use case above.

The thread synchronization required above presents a technical problem that induces significant GPU overhead when queuing NVMe commands and getting their completion status. This overhead is incurred by the threads on the GPU when the threads synchronize the access to NVMe submission queues (SQs) and completion queues (CQs). Implementing this synchronization code robs processing cycles and/or resources from the GPU (e.g., a Streaming Multiprocessor (SM) of the GPU).

Now discussing this increased overhead need in more detail, on an NVIDIA GPU, for example, threads run on Streaming Multiprocessors. A GPU contains typically between one and two hundred SMs. Each SM can run several hundreds of thousands of threads in parallel.

Similarly to the NVMe use case above, it can be desirable to have only one thread at a time using a QP. In such case, there could be a need, for example, for several hundred thousand NVMe QPs. Each QP would have one or very few NVMe commands (and most of the time typically only one command) queued in the QP submission queue. The creation of these QPs would be time-consuming, and these QPs would waste a lot of SSD hardware resources.

Having a limited number of NVMe QPs available, one can consider how the use of the QPs might potentially be optimized in the above GPU use case. Noting that all threads running on a same Streaming Multiprocessor (SM) share the same L1 cache, an efficient use of NVMe QPs is to use one QP per SM. Any thread running on the SM can use the QP associated to the SM. Doing so guarantees that the serialization atomic variables (e.g., used to serialize access to the QP across threads running in parallel on the SM, one set of atomic variables per QP) and the QP itself stays in the SM L1 cache. No other thread running on another SM is going to access the QP.

When contention happens (e.g., several threads running on the same SM post in the SQ or read the CQ), the contention is handled in the SM L1 cache, and there is no need to access the GPU main memory. This reduces SM thread stalls (e.g., cache miss is avoided) by handling the contention in L1 cache, and also reduces the usage of memory bandwidth.

However, the above approach still has significant limitations. Specifically, the threads running on a same SM must wait in turn to access the QP, one after the other. The threads wait by looping doing atomic operations on the QP atomic variables, to know when it is a thread's turn to access the QP. This creates undesirable SM overhead. Also, when one thread is accessing an atomic variable, no other thread can run on the same SM. In contrast, a warp (32) of threads can be running simultaneously on the SM.

In some approaches, a part of the queueing can be done in the same SQ in parallel (e.g., writing NVMe commands in parallel in different entries of the SQ). But these approaches themselves also require the use of atomic variables. Some parts of the queuing cannot be done in parallel. For example, the SQ doorbell update and ensuring that SQ content is consistent with the doorbell value must still be serialized. For completion queues (CQs), memory atomic operations are used again to synchronize several SM threads reading the CQ associated to the SM.

Thus, even if attempts were made to improve queuing by assigning QP(s) per SM (e.g., atomic memory variables used for synchronization stay in L1, and contention is reduced to intra SM) and writing is done in parallel in SQ entries, there is still undesirable overhead having the SM use atomic memory operations (e.g., in particular at high frequencies).

At least some techniques provided in the present disclosure address the above and other deficiencies and challenges by using an array pair for accessing a memory sub-system. The array pair includes a send array and a completion array. The send array is used for sending commands to the memory sub-system. The completion array is used for receiving completion records from the memory sub-system as execution of the commands is completed.

In some embodiments, the send array and completion array each contain slots that can be accessed randomly using a same index. This random access is in contrast to the existing submission and completion queues, which are accessed sequentially. The indexes permit identifying and accessing corresponding pairs of slots of the send and completion arrays.

An index is assigned to each thread doing an IO that is running on a graphics processing unit (GPU). By assigning each thread to a different index, thread contention for access to the array pair is avoided. Only one thread is assigned to each available index of the send array at any given time.

For example, index 3 is assigned to a thread. The thread generates a command that is stored in slot 3 of the send array. A controller of a memory sub-system retrieves the command from slot 3. After executing the command, the controller writes a completion record to slot 3 of the completion array.

In one example, multiple threads are running on a streaming multiprocessor of a GPU. Each thread that will perform IO can access any available slot of an array pair that is allocated to the streaming multiprocessor. A scheduler of the streaming multiprocessor can assign a slot index to each thread needing to perform IO. Each thread has its own index and does not need to know what operations are being performed by other threads. This avoids the need for thread synchronization when two or more threads are trying to use the send array at the same time.

The host system notifies the memory sub-system that a command is available in the send array by sending one or more slot indexes to a doorbell register of the memory sub-system. In response receiving the index, the controller of the memory sub-system retrieves the command of the corresponding slot in the send array that is identified by the index. After executing the retrieved command, the controller generates a completion record. The completion record is sent to the slot of the completion array that corresponds to the same index as for the executed command.

In one example, configurations of the commands written to the send array by a thread are in accordance with a current standard of NVMe (e.g., NVM Express NVM Command Set Specification, Revision 1.1 of Aug. 5, 2024; and NVM Express Base Specification, Revision 2.1 of August 5, 2024, the contents of which are hereby incorporated herein by reference).

In one example, a GPU accesses a solid-state drive using an array pair. The current standard of NVMe is extended to provide for use of array pairs. Commands generated by threads of the GPU are in accordance with the existing NVMe standard. Completion records generated by the SSD are reduced in size as compared to completion records in accordance with the existing NVMe standard.

In one embodiment, an array pair (AP) includes a Send Array (SA) and a Completion Array (CA). The SA can reside in GPU memory or in memory of the SSD (e.g., controller memory buffer (CMB)). Because the SA is an array, and not a queue, the SA does not have a head or tail. In one example, similarly to a NVMe 2.0 Submission Queue (SQ), the SA contains slots each having a size of 64B. In another example, commands of a reduced size that are not fully compatible with the NVMe standard can be used (e.g., slots having a size of 24B).

The SA is associated with one or several doorbell registers in SSD memory (e.g., using a BAR). If several doorbell registers are used, then each doorbell register is located on a different SSD. Send array slot indexes are written by the host system in the doorbell registers.

Similarly to an NVMe 2.0 Completion Queue (CQ), a CA contains NVMe completion records. Completion records for commands fetched from a send array can have a reduced size because there is no need to reference the command being sent via the send array. Similarly, a command being sent via the send array can eliminate the Command Identifier (Command ID) field, since it is no longer needed in the corresponding completion record to indicate for which command the completion record is provided (it is for the command in the corresponding slot in the send array). The CA is located in GPU memory. For example, the size of a completion record can be 8 bytes (as contrasted to a size of 16 bytes in an existing CQ).

In one example, a portion of GPU memory is allocated for providing buffers to store the AP (send array and completion array). In one example, the maximum size of the SA or CA buffer is 2\hat{ }32 slots. This allows SA slot indexes to have a size of 4 bytes. If an AP with more than 4G slots is needed, several APs can be allocated.

In some embodiments, an array pair can be shared amongst multiple memory sub-systems. In one example, the AP is located in GPU memory and shared across several SSDs. In contrast, such sharing not possible with an NVMe 2.0 QP.

An association between the AP and each SSD can be referred to as an AP channel. The AP channel includes the AP and a corresponding doorbell register in each SSD. When the AP is shared, it has several SA doorbell registers, one per channel (one doorbell per SSD sharing the AP). In one example, a benefit of sharing the AP is a reduction in the GPU memory footprint required to perform direct IO with the SSD.

In some embodiments, the AP channel can be created similarly as done for an NVMe 2.0 QP. An SSD can support a maximum number of AP channels, and the GPU manages the creation of the AP channels. To create an AP channel, software executing on the GPU (e.g., GPU configuration code) first allocates the AP buffers (for SA and SA) and then creates one or more AP channels by communicating with each SSD with which a channel is created. If several AP channels are created, each SSD receives the same SA address and same CA address from the GPU because the AP is shared.

In one example, a processor (e.g., GPU) generates commands retrieved by an SSD from the send array over a PCIe bus. For example, the processor can be a GPU Streaming Multiprocessor (e.g., NVIDIA GPU), a host core, or other similar physical processing unit running code that issues NVMe commands.

In one embodiment, a memory sub-system stores data in non-volatile memory cells. A controller of an SSD receives access commands. In response to receiving each access command, the controller executes the corresponding access command to perform an operation on the non-volatile memory cells.

In one embodiment, an SSD includes at least one non-volatile memory device and one or more controllers. The SSD stores data for a host system on which a plurality of threads execute for training a neural network(s). One or more of the threads are each assigned to a different slot index number for reading a page of data into a slot of a cache (e.g., a software cache in GPU memory).

In one embodiment, a memory sub-system (e.g., an SSD) is configured to provide access to a host system. The host system can read/write the SSD using an NVMe block command set based on addressing in a block namespace, where the full LBA block of data is transmitted across the PCIe bus for read or write.

In one example, a read and write can be performed using an NVMe memory namespace command set. An SSD can be configured to perform a read operation to retrieve the data from a set of memory cells allocated as the storage resources of an LBA block.

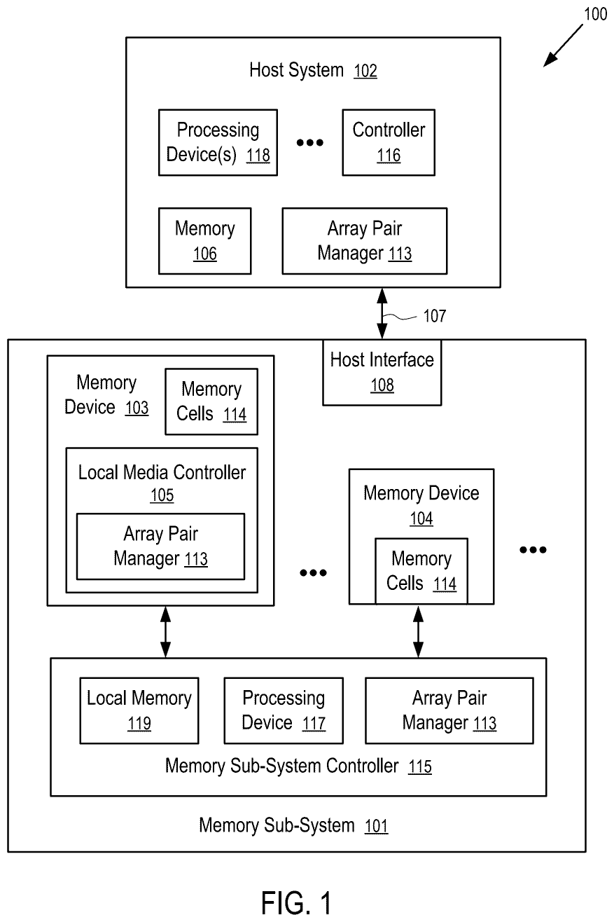

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include array pair manager 113 configured to manage an array pair used to access memory sub-system 101. For example, array pair manager 113 of controller 115 retrieves access commands from a send array located in memory 106. For example, array pair manager 113 of host system 102 selects slot indexes to be used for writing the access commands into the send array. In various embodiments, the array pair manager 113 is used to exchange input/output (IO) commands and completions between a host system (e.g., a GPU) and a memory sub-system (e.g., an SSD).

In some embodiments, the controller 115 in the memory sub-system 101 includes at least a portion of the array pair manager 113. In other embodiments, or in combination, the controller 116 and/or the processing device 118 in the host system 102 includes at least a portion of the array pair manager 113. For example, the controller 115, the controller 116, and/or the processing device 118 can include logic circuitry implementing the array pair manager 113. For example, the controller 115, or the processing device 118 (processor) of the host system 102, can be configured to execute instructions stored in memory for performing the operations of the array pair manager 113 described herein. In some embodiments, the array pair manager 113 is implemented in an integrated circuit chip disposed in the memory sub-system 101. In other embodiments, the array pair manager 113 can be part of firmware of the memory sub-system 101, an operating system of the host system 102, a device driver, or an application, or any combination therein.

For example, the array pair manager 113 implemented in the controller 115 and/or 105 of the memory sub-system 101 can manage writing commands to a slot of a send array, writing a slot index to a doorbell register of memory sub-system 101, and writing a completion record to slot of a completion array. Host system 102 sends commands to the memory sub-system 101 over a PCIe fabric. Controller 115 executes the commands (e.g., NVMe commands) to access memory device 103.

In one example, the controller 115 can run the array pair manager 113 of the memory sub-system 101 to retrieve commands from the host system 102 over a PCIe fabric. Controller 115 executes the commands (e.g., NVMe commands) to access memory device 103. Controller 115 indicates completion of the commands to host system 102 by sending signals over the PCIe fabric.

In one example, managers in the host system 102 and in the memory sub-system 101 are configured to establish namespaces. For example, the namespace can be an NVMe block namespace. The smallest unit of storage space accessible in the namespace is a block represented by a respective address defined in the namespace to represent the block. For example, the storage size of a block can be 512 bytes or more (e.g., 4096 bytes). A set of physical storage resources (e.g., memory cells 114) are allocated to implement the physical storage space represented by the namespace.

In one example, memory sub-system 101 is configured to access a region of storage locations. Host system 102 can use a protocol (e.g., a NVMe block command set) to send an access request to an SSD. The access request is directed to an address in a namespace; and the memory sub-system 101 can provide a corresponding response using the protocol.

For example, the access request sent to the SSD can be a read command. The memory sub-system 101 can execute the read command and determine the storage resource allocated to implement a logical block having the address defined in the namespace. The memory sub-system 101 then retrieves a data block from the storage resource, and sends the data block across the computer bus 107 to the memory 106 of the host system 102, as instructed by the access request according to the protocol.

For example, the access request sent to the SSD can be a write command. The memory sub-system 101 can use an address map to determine a storage resource block allocated to implement a logical block having the address defined in the namespace. After retrieving the data block from the memory 106 of the host system 102, as instructed by the access request according to the protocol, the memory sub-system 101 can program the storage resource block to store the data block obtained from the memory 106 of the host system 102.

Further details of the operations of the array pair manager 113 in the host system 102 and in the memory sub-system 101 are discussed below.

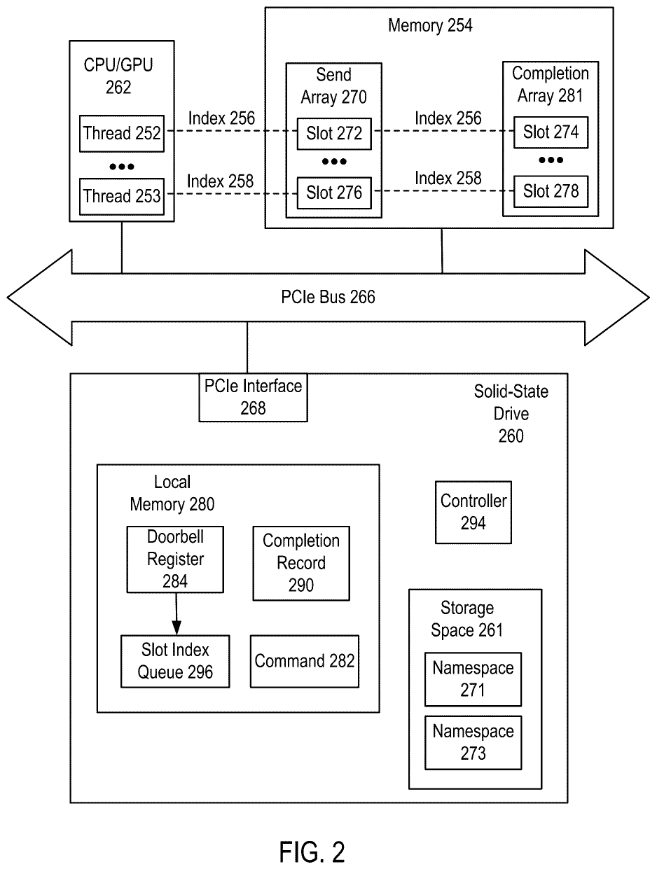

FIG. 2 shows an array pair used by a host system to access a solid-state drive 260 according to one embodiment. CPU/GPU 262 communicates with memory 254 and solid-state drive 260 using PCIe bus 266. Memory 254 has a send array 270 for holding commands (e.g., NVMe read or write commands 282) to be retrieved by the solid-state drive 260. CPU/GPU 262 generates the commands and places each command into one of slots 272, 276 of send array 270. CPU/GPU 262 and memory 254 are an example of host system 102. Solid-state drive 260 is an example of memory sub-system 101.

CPU/GPU 262 assigns an index to each thread running on CPU/GPU 262 that will perform an IO operation. For example, thread 252 is assigned index 256, and thread 253 is assigned index 258. Each index 256, 258 identifies a corresponds to a pair of slots in memory 254. Specifically, index 256 identifies slot 272 of send array 270 and slot 274 of completion array 281. Index 258 identifies slot 276 of send array 270 and slot 278 of completion array 281. Indexes 256, 258 are used by CPU/GPU 262 and solid-state drive 260 for randomly accessing various slots in send array 270 and completion array 281.

After a command 282 is written into a slot of send array 270, CPU/GPU 262 writes the corresponding index to doorbell register 284. For example, thread 252 writes command 282 into slot 272. Then, the index 256 is written to doorbell register 284. Immediately upon receiving index 256, an application specific integrated circuit writes the index 256 into slot index queue 296.

Controller 294 processes each index in slot index queue 296 by retrieving the command from the corresponding slot in send array 270 that is identified by the index. For example, controller 294 retrieves command 282 from slot 272 using index 256. The retrieved command 282 is temporarily stored in local memory 280 until executed by controller 294. After command 282 has been executed, controller 294 generates completion. Controller 294 writes completion record 290 to slot 274 of completion array 281. Controller 294 is able to identify the slot 274 by using index 256. Thread 252 polls slot 274 and determines the command 282 has been executed based on the completion record 290 being written in slot 274. In one example, thread 252 determines completion based on a value of a phase bit in completion record 290.

Solid-state drive 260 retrieves the commands from the send array 270 via PCIe interface 268. The retrieved commands are buffered in the local memory 280 of the solid-state drive 260. In one example, memory 280 is a command queue of solid-state drive 260. In one example, memory 280 is buffer memory or local random access memory for temporary storing of commands waiting to be processed/executed.

In some embodiments, each command 282 has a common size in bytes. In one example, the data structure of the command 282 corresponds to a command structure defined in a current version of the NVMe standard; and each field in the command 282 corresponds to a predefined location (e.g., bit segments) in the command to provide a parameter in a way defined in the NVMe standard.

Each command 282 includes an indication of a type of processing to be performed by controller 294 when executing the command. The indication indicates how each field of the command is to be processed. For example, the field is a data pointer or starting LBA address. For example, the field is Dword 13 of an NVMe read command containing parameters/options (e.g., for Dataset Management and/or other parameters).

In one example, SSD 260 has a DMA engine (not shown) to retrieve data/commands from the memory 254 and write data/completion records to the memory 254. The data in a slot in a send array 270 (e.g., as configured according to the NVMe standard) is seen by the solid-state drive 260 as a command. The controller/processor 294 of the SSD checks various segments/fields of the data/command to determine what operations/tasks the CPU/GPU 262 wants the SSD to perform by entering the command/data in the slot 272, 276.

In some embodiments, command 282 is configured in accordance with a current version of NVMe standard. Each command 282 has a total size of 64 bytes, or 16 Dwords (double words), that can be referenced as Dword 0 to Dword 15. When Dword 0 has the opcode value for a read as defined in a current NVMe standard, the command is interpreted as a read command; when the Dword 0 has the opcode value for a write as defined in a current NVMe standard, the command is interpreted as a write command.

SSD 260 includes storage space 261. For example, the storage space can be implemented via NAND flash memory. A read/write command is executed in the SSD 260 to read data from, or write data into, storage space 261.

The capacity of the storage space 261 can be partitioned into one or more namespaces 271, 273. Physical storage resources (e.g., NAND flash memory) are allocated to implement logical storage blocks in namespaces 271, 273. A namespace 271 or 273 can have a plurality of logical storage blocks, each having a same size and represented by a logical block addressing (LBA) address configured in the respective namespace 271 or 273. For example, to specify a location in the storage space 261, a fast or normal read/write command can specify a namespace identifier in a “namespace identifier” field configured in the respective command (e.g., Dword 1 or bytes 7:4 of the command), and an LBA address in a “Starting LBA (SLBA)” field in the respective command (e.g., in Dwords 10-11 or bytes 47:40 of the command), where the LBA address is defined specifically in the namespace represented by the namespace identifier.

In one embodiment, index 256 is assigned to a GPU thread 252 that is doing an IO. The corresponding slot 272 in SA 270 and slot 274 in the CA are at the same index 256 in both arrays (slots 272/274 together are sometimes referred to as an AP slot). The AP slot assigned to the GPU thread 252 is used only by that thread (for the time of the IO).

Slot Index Queue (SIQ) 296 is an internal queue on the SSD 260. There is one SIQ per Array Pair (AP). It contains indexes of slots in the SA that have been written to doorbell register 284 (e.g., by threads 252, 253).

In one example, a GPU thread 253 writes NVMe command 282 in its assigned slot (e.g., slot index 3) in the SA 270. Next, the GPU thread 253 writes the slot index 3 in doorbell register 284 using a transaction layer packet over PCIe bus 266. An application specific integrated circuit (ASIC) in SSD 260 processes the TLP as it arrives to the doorbell register 284 and copies the slot index 3 into internal slot index queue 296. Controller 294 processes the slot indexes stored in the slot index queue 296. Using index 258 from the SIQ 296, SSD 260 reads the corresponding slot 276 in the SA 270.

The SSD 260 processes the retrieved command 282 (e.g., processes the command as defined in NVMe spec 2.0). After the command 282 is executed, the SSD 260 writes completion record 290 in the CA 281 slot 278 (using the same index 258 as for the corresponding SA slot 276. GPU thread 253 is polling slot 278 CA[3] and notices the phase bit of completion record 290 has changed. Thread 253 determines this to be a completion of execution for command 282.

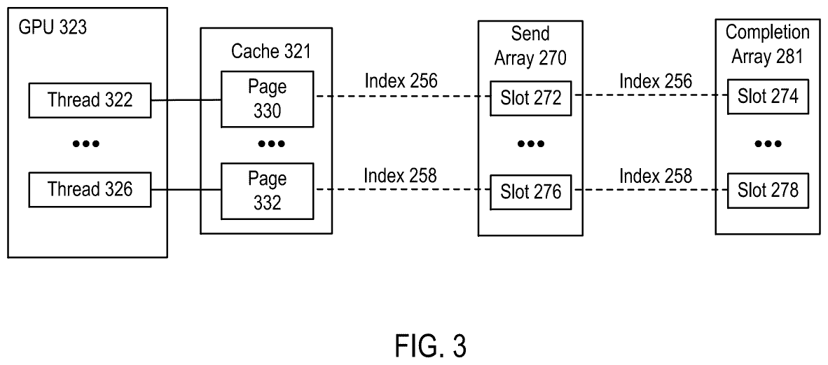

FIG. 3 shows an array pair allocated to a cache 321 according to one embodiment. The array pair includes send array 270 and completion array 281. Various threads 322, 326 are running on GPU 323. Each thread is assigned an index for performing IO. Threads 322, 326 read pages of data 330, 332 from a memory sub-system (e.g., SSD 260). Each page of cache 321 is stored in a slot that is identified by an index. Each slot of cache 321 corresponds to a pair of slots in the array pair identified by the same index.

For example, thread 322 reads page 330 of data from storage space 261 using index 256. Page 330 is read by thread 322 writing a read command 282 into slot 272.

In one example, cache 321 is an L1 or L2 cache of GPU 323.

In one example, thread 322 writes page 330 of data from cache 321 to storage space 261 (e.g., to evict a dirty page). Page 330 is written by thread 322 writing a write command 282 into slot 272.

In other embodiments, instead of using the same index 256 or 258 for corresponding slots in the send array 270 and the completion array 281, more generally each index for a slot in the send array 270 uniquely corresponds to an index for a slot in the completion array 281. Various mappings of send array indexes to completion array indexes can be used. For each mapping, an index of a single slot of the send array corresponds one-to-one with a single slot of the completion array.

In one example, a controller of a memory sub-system determines a slot index for completion array 281 based on the slot index for send array 270 that has been received in doorbell register 284.

In one example, GPU 323 or a controller of a memory sub-system can use a slot index to determine the memory address of the slot in the send array. The memory address of the slot is computed using a base address of the send array, and then adding an offset from the base address computed using the index multiplied by a common size of the slots in the send array. The memory address of a slot in the completion array can be computed similarly.

GPU 323 allocates a portion of memory (e.g., memory 254) for the array pair. GPU 323 provides an address of send array 270 and an address of completion array 281 to one or more memory sub-systems. GPU 323 associates a respective doorbell register of each memory sub-system with the array pair.

Regarding sizing of the array pair, to avoid GPU thread contention, there must be as many AP slots (i.e., SA slot and corresponding CA slot) as the number of threads that may concurrently send NVMe commands. If this is done, any thread ready to send an NVMe command will always have a free AP slot available for writing the command to the send array. Thus, there is no contention for that thread to acquire an AP slot.

The SSD is configured to correspondingly handle as many SA slots (across one or several APs) as needed based on the size (number of slots) of the array pair allocated by the host. Also, the size of the slot index queue in the SSD is configured to accommodate as many slot indexes as the number of slots in the SA.

The approach used to allocate the array pairs can vary depending on the configuration of the GPU software running on the GPU and/or the GPU hardware.

In one embodiment, a single AP is allocated for each software cache 321 For example, one AP is allocated for each cache instance.

In one example, the number of corresponding slots in send array 270 and completion array 281 is equal to the number of slots in a cache 321. This single AP is used to service functions of the cache. For example, threads doing IO at any given time are limited to using a maximum of one thread per cache slot. Each of the threads can only perform a single IO at any given time. The thread initiates the IO and then polls the slot identified by the index in the completion array 281 for completion before performing other actions. As a result, each thread has its own dedicated slot or entry in the array pair at position given by the index assigned to the thread (AP[index]). The AP index corresponds to the cache slot in which the thread loads a page 330, 332 (the thread reading in or flushing dirty data for the cache slot “i” uses AP[i]).

In one example, a software cache is used. Any IO is done in the context of reading a page into a cache slot or flushing a dirty page when evicted. Cache management software selects one unique GPU thread to do each read or write. For example, consider that that a read or write needs to be performed for cache slot i. The GPU thread in charge of doing the read or write in/from the slot i uses AP[i] to perform that operation. Any other GPU thread that happens to be doing IOs at the same time does IOs on other, different cache slots (e.g., slots j and k). The GPU thread doing an IO for the slot j uses AP[j], and the thread doing an IO on slot k uses AP[k]. Thus, when the GPU thread in charge of updating the cache slot i uses AP[i] for that operation, no other thread will be using AP[i].

The cache management software ensures that only one thread handles the reading of data into one cache slot or flushing the slot. Each cache slot is assigned one AP[ ] element.

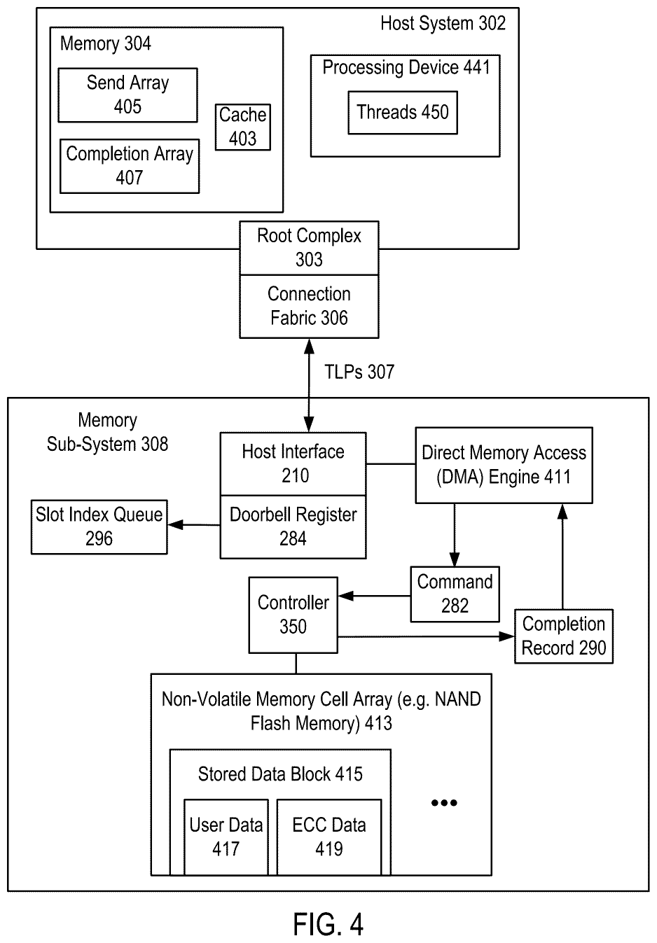

FIG. 4 shows a host system 302 that writes a slot index of send array 405 to doorbell register 284 of memory sub-system 308 according to one embodiment. In response to receiving the slot index, controller 350 retrieves command 282 from send array 405. Controller 350 and/or direct memory access (DMA) engine 411 compute a memory address in the send array 405 using a base address of send array 405, the size of the slots in send array 405, and the slot index. DMA engine 411 fetches the command from the computed memory address for the slot assigned to the slot index.

Commands 282 retrieved from send array 405 are transferred from host system 302 using transaction layer packets 307. Host interface 210 receives TLPs 307 from connection fabric 306.

In response to receiving each command 282, controller 350 executes the command 282 to access non-volatile memory cell array 413. In one example, command 282 is a read command; and user data 417 and ECC data 419 are read from stored data block 415. ECC data 419 is used to correct any errors found in user data 417. DMA engine 411 transfers the read user data 417 to a memory location identified by a data pointer of command 282.

In one example, command 282 is a write command; and user data 417 and ECC data 419 are written to stored data block 415. DMA engine 411 transfers the user data 417 to be written from a memory location identified by a data pointer of the write command 282.

After execution of command 282 is completed, controller 350 generates completion record 290. Completion record 290 is transferred by DMA engine 411 to a slot of completion array 407 that corresponds to the slot of send array 405 from which command 282 was retrieved. The memory address for the slot in completion array 407 can be computed using a base address of completion array 407, the common size of the slots in completion array 407, and the slot index received by doorbell register 284 that was used to retrieve command 282.

Memory sub-system 308 is an example of memory sub-system 101. Host system 302 is an example of host system 102. Host system 302 and memory sub-system 308 communicate over connection fabric 306. In one example, connection fabric 306 is a PCIe fabric. Connection fabric 306 includes a root complex 303. For example, root complex 303 can be implemented by hardware of host system 302, or can be implemented on a separate chip.

In one example, memory 304 is main memory of host system 302. In one example, when instructed by controller 350, direct memory access (DMA) operations on memory 304 are performed by DMA engine 411 according to various commands received from host system 302.

In one embodiment, host system 302 sends slot indexes to doorbell register 284 using transaction layer packets 307 (e.g., TLPs according to a PCIe protocol). Each TLP 307 can include one or more slot indexes.

In one embodiment, an ASIC copies slot indexes received in doorbell register 284 to slot index queue 296 in response to receiving a transaction layer packet(s) written to the address of the doorbell register 284. The root complex 303 of the connection fabric 306 commits each TLP aligned on a boundary having a fixed size in bytes. Each TLP has a data payload that is equal to or a multiple of the fixed size. The data payload includes, for example, a slot index for a command written to send array 405 by a thread 450 executing on processing device 441. In one embodiment, multiple slot indexes can be delivered to the memory sub-system using a single transaction layer packet.

In one embodiment, one or more threads 450 write commands 282 to slots in send array 405. When executed in the memory sub-system 308, the commands cause pages 330, 332 of data to be written to or read from cache 403. In one example, DMA engine 411 transfers user data 417 from stored data block 415 to cache 403 in response to retrieving a read command 282. In one example, processing device 441 flushes a page of dirty data from cache 403 for the memory sub-system 308 to store as data block 415. Cache 321 is an example of cache 403.

In one embodiment, cache 403 is used by a thread 450 to perform operations. For example, cache 403 is high bandwidth memory (HBM). For example, cache 403 is a software cache of a GPU.

An array pair is allocated to cache 403 by processing device 441. The array pair includes send array 405 and completion array 407. Each slot of cache 403 is associated with a slot of send array 405 and a corresponding slot of completion array 407.

Thread 450 uses read commands to read pages of data into cache 403. One page is read per slot in cache 403. Thread 450 modifies the data in one or more slots of the cache 403. Each page that is modified is marked as being dirty at that time. The dirty pages remain in cache 403 until more room is needed in cache 403 for a different page(s). At that time, one or more pages in cache 403 are evicted from the cache 403 to the memory 304. If the evicted page is dirty, then thread 450 enters a write command in the send array 405 to write the page of data to memory sub-system 308. Writes to memory sub-system 308 of pages in cache 403 are only done when evicting a dirty page.

In one example, when controller 350 executes a read command 282, a backend application-specific circuit (not shown) reads at least a portion of user data 417 and corresponding ECC data 419 from stored data block 415. Error correction circuitry (not shown) is used to correct any errors found in the read data.

In one example, when controller 350 executes a write command 282, the backend application-specific circuit programs memory cells of memory cell array 413 to store user data 417 transferred from memory 304 (e.g., DRAM) of host system 302. The error correction circuitry generates ECC data 419 for the user data 417 to be written. The memory cells are programmed so that states of the memory cells correspond to the user data 417 and ECC data 419 to be stored as part of executing write command 282.

In one example, in response to a read command 282, a backend application-specific circuit reads user data 417 using operations defined by parameters that identify an LBA address of a logical block from which data is to be read. A flash translation layer converts the LBA address into a physical address in non-volatile memory cell array 413. The corrected user data 417 is transferred to memory 304 using direct memory access engine (DMA) 411. For example, user data 417 is transferred to a memory address of memory 304 provided by a data pointer field of read command 282.

In response to a write command 282, the backend application-specific circuit writes user data 417 using operations defined by parameters that identify an LBA address of a logical block in which data is to be written. A flash translation layer converts LBA address into a physical address in non-volatile memory cell array 413. The user data 417 to be written is transferred from memory 304 using direct memory access engine (DMA) 411. For example, user data 417 is transferred from a memory address of memory 304 provided by a data pointer field of write command 282.

In one embodiment, doorbell register 284 has a size that is a multiple of a fixed size unit (e.g., a unit of 4 bytes). Doorbell register 284 is defined as a range in a PCIe BAR address space.

In one embodiment, doorbell register 284 has multiple slots each used to hold one slot index. Each slot has a predetermined fixed size. In one example, each slot index is sent as a data payload of a TLP 307. In one example, a data payload of a TLP includes multiple slot indexes, each having the same size.

In one embodiment, multiple commands 282 are retrieved from send array 405 using a single PCIe read request. This can improve efficiency of PCIe bus usage. Controller 350 reads two or more commands 282 from send array 405 with one PCIe read request, instead of issuing a PCIe read request for each individual command. Commands 282 that are located at contiguous addresses in send array 405 can be coalesced into a single TLP 307.

In one embodiment, software (e.g., threads 450) executing on processing device 441 writes commands in send array 405 using an increasing slot index order. This can increase the probability of slot indexes written to doorbell register 284 being in a consecutive order so that the corresponding commands can be coalesced in a single TLP 307. For example, a command issued at time t is copied in SA[n], a command issued at time t+1 is copied in SA[n+1], etc. As a result, the slot indexes are written to doorbell register 284 in consecutive order (e.g., 3,4,5,6,7, . . . ).

In some cases, the slot indexes may be written slightly out of order (e.g., 3,5,4,7,6, . . . ). Controller 350 can reorder the sequence of slot indexes in preparation for using a single TLP 307. In some cases, there may be one or more holes in the slot index sequence written to doorbell register 284. In such case, controller 350 can add the one or more missing slot indexes to the sequence for the purpose of using a single TLP to retrieve multiple commands. Each command retrieved that corresponds to one of the missing slot indexes can be ignored by the controller 350.

In one embodiment, slot index queue 296 is scanned to determine the ordering of slot indexes. Slot indexes that are out of order by less than a threshold (e.g., a threshold number of slot index positions) can be reordered to provide a consecutive sequence. Controller 350 issues one PCIe read request for all the commands of the reordered sequence. If a sequence of indexes (to be made consecutive when re-ordered) has a small hole, controller 350 can fill the hole with the missing slot index and read the sequence of contiguous commands in send array 405 using a single PCIe read request. The command read that corresponds to the missing slot index hole is ignored by memory sub-system 308.

In one embodiment, cache 403 is allocated to send array 405 and completion array 407. When new pages are read into cache 403, processing device 441 needs to evict dirty pages from slots in cache 403 to make room for the new pages. This eviction is done in cache slot order. For example, evict cache_slot[i], then evict cache_slot[i+1], etc. This results in writing a read command 282 in SA[i], then writing the next command 282 in SA[i+1]. This provides slot index numbers in consecutive order.

In some cases, there may be some holes in the order. For example, if the next cache_slot[i+1] in sequence order contains a page that is actively used by one or more threads, this slot is skipped.

In some cases, slot index queue 296 may be full when the host system 302 pushes slot indexes at a rate exceeding the maximum input/output operations (IOPs) for commands retrieved from the send array 405 that can be supported by the SSD. If the slot index queue 296 is full, the SSD can signal the host system (e.g., by sending a retry signal). Alternatively, the SSD can regulate credits provided to the host system for memory writes.

In one embodiment, commands 282 are processed by memory sub-system 308 in the same way as for commands according to a current version of the NVMe standard.

In one embodiment, threads 450 are executing in host system 302. Processing device 441 includes one or more cores (not shown). Each core executes one or more threads 450. Threads 450 are executed, for example, during training of one or more neural networks. During the training of the neural networks, various weights used in the training can be stored in memory sub-system 308 in response to write commands written by one or more threads 450 to one or more slots of send array 405. The weights can also be read from memory sub-system 308 in response to read commands sent by one or more threads 450 to one or more slots of send array 405.

In one example, many threads 450 execute in parallel during training of a neural network. Each thread 450 can perform an IO at the same time by each thread 450 using a different slot of send array 405.

When command 282 is retrieved from send array 405, command 282 includes an initial value for a phase bit. After execution, controller 350 generates completion record 290. Completion record 290 includes a final value for the phase bit. The final value indicates a status of the execution.

In one example, when the command 282 is retrieved, the phase bit includes an initial value based on stored content. When controller 350 generates and writes completion record 290, controller 350 inverts the initial value of the phase bit to provide the final value of the phase bit. This permits host system 302 to determine that the content in the completion record 290 is new, updated, and/or valid. An advantage of using the phase bit is that the host system 302 does not need to immediately process the completion record when controller 350 writes it to completion array 407.

In one embodiment, completion array 407 is not used. A completion record 290 can be written back to the slot in send array 405 from which the command is retrieved.

In one embodiment, it is not necessary to assign a fixed slot/index/memory address in send array 405 for thread 450. A slot index can be dynamically assigned/mapped when the thread 450 is to write a command 282 to a slot in send array 405.

In one embodiment, it is not necessary to limit a thread 450 to using only one slot of send array 405. For example, a busy thread can use multiple slots.

In one embodiment, because host system can ring doorbell register 284 for only a limited number of slots, it is not necessary to have a large array in which many or most of the slots are unused or waiting. A small array can be used for the limited number of slots/commands that will be retrieved.

In one embodiment, it is not necessary to write the address/index/slot ID into the doorbell register 284. Instead, a number of slots that have commands in the send array 405 is written to doorbell register 284.

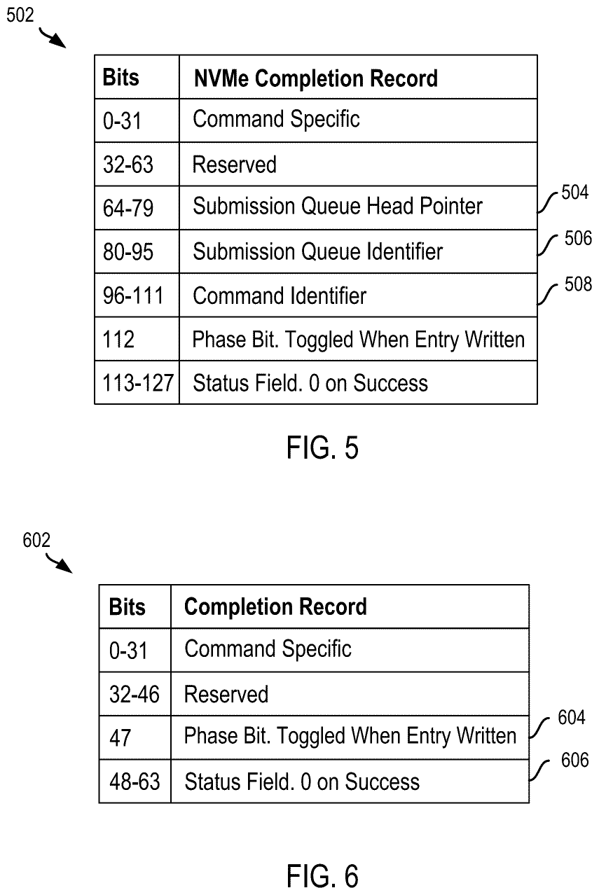

FIG. 5 shows a configuration 502 of completion records generated for sending to a completion queue. Configuration 502 includes field 504 for a submission queue head pointer, field 506 for a submission queue identifier, and field 508 for a command identifier. These fields are configured according to the NVMe standard.

FIG. 6 shows a configuration 602 of completion records generated for sending to a completion array according to one embodiment. In one example, configuration 602 is used for generating completion records 290.

Configuration 602 includes field 604 for a final value of a phase bit. In one example, the final value is the value of the phase bit in completion record 290. Configuration 602 includes field 606 for status data.

In one embodiment, the size of configuration 602 is smaller than the size of configuration 502. For example, a completion record according to configuration 502 has a size of 16 bytes. A completion record according to configuration 602 has a size of eight bytes. Configuration 602 can be made smaller because fields 504, 506, 508 are not needed when using an array pair.

In addition, certain bit locations of configuration 502 are removed to make the completion record smaller. For example, configuration 602 has bits 47-63, which correspond to bits 112-127 of configuration 502. Bits 32-63 of configuration 502 is a reserved field. A portion of this reserved field is removed to shorten the completion record so that the size of configuration 602 is eight bytes.

In one embodiment, when an array pair is allocated by a GPU, a phase bit in each slot of a completion array is zeroed. When the GPU creates AP channels in collaboration with one or more SSDs, each SSD assumes that the phase bits for all slots are zero. The SSD keeps track of the value of the phase bit it last wrote for each slot in the completion array (CA[ ]). For example, these values can be stored in an array CA_phasebit[ ] on the SSD.

In one example, GPU thread 450 writes a command 282 in send array SA[i], and writes slot index “i” in the SA doorbell register of an SSD. The SSD retrieves and processes the command. The GPU thread 450 starts to poll the completion array slot CA[i] corresponding to the slot index i. The SSD generates the completion record and writes the completion record GPU memory. The SSD sets the phase bit in the completion record to the 1's complement of CA_phasebit[i]. Then, the SSD flips CA_phasebit[i]. The SSD writes the completion record at CA[i]. The GPU thread 450 sees in CA[i] that the phase bit has flipped when reading the completion record.

In some embodiments, PCIe communication efficiency can be increased by sending multiple completion records in a single transaction layer packet 307. For example, an SSD can group several contiguous completions in one PCIe write request. This can be done if the completion records are to be written to slots located at contiguous addresses in the completion array.

In one embodiment, a sequence of new completion records are to be written to contiguous slots in the command array except that the sequence includes one or more holes. In other words, new completion records for one or more slot indexes in the sequence are missing. For example, a sequence of completion records at different slot indexes is as follows: CA[22], CA[23], CA[24], CA[26], CA[27], CA[28]. There is no new completion record at slot index CA[25]. In such case, the SSD can write the full contiguous sequence including the hole. This does not cause a misinterpretation by the host system because the phase bit of the completion record is not flipped for the hole in the sequence (e.g., CA[25]).

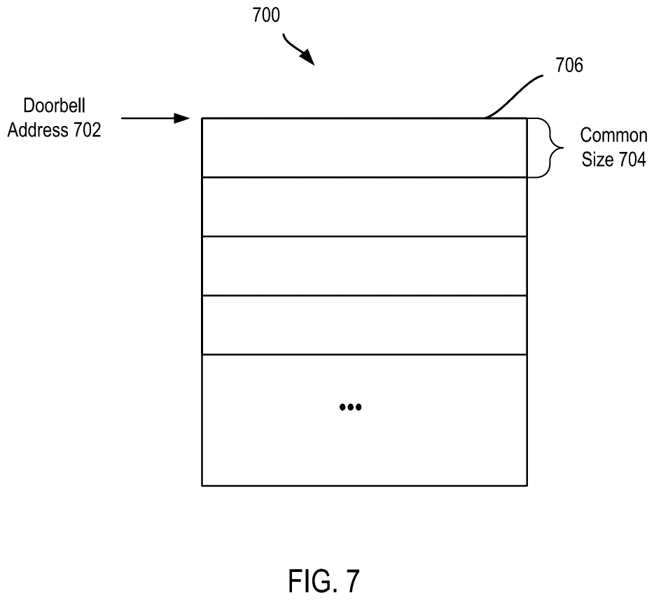

FIG. 7 shows different offsets used to write slot indexes into a doorbell register 700 according to one embodiment. The doorbell register 700 is a segment of memory addresses 706. Each slot index has a common size 704 (e.g., four bytes) when written to doorbell register 700.

In one example, each row is one byte (1B); and the doorbell covers N bytes, starting from doorbell address 702. Each index for a slot in a send array has the size of 4 bytes. Thus, the first 4 bytes in the doorbell register can hold one slot index, and the second 4 bytes can hold another slot index. An offset (n) can be used when writing slot indexes into doorbell register 700. The offset n identifies a number of four byte slots following the doorbell address 702. When the doorbell register 700 can hold only 32 bits (four bytes), doorbell register 700 can hold only one index. More generally, doorbell register 700 holds multiple slot indexes at different offsets n.

In one example, an address of a portion of doorbell register 700 to use for writing a slot index can be computed from: doorbell address 702+index-size-in-bytes X index-of-slot-in-doorbell-register. By using such offsets to compute addresses, threads running on a host can independently write to different portions of the doorbell register 700 without coordination at the host.

In one example, each slot index can be written to one of multiple slots in doorbell register 700 (e.g., Slot 0, Slot 1, . . . Slot N−1). Each of slots 706 has a common size 704 (e.g., four bytes). The address of doorbell register 700 into which a slot index is written can be computed as doorbell register address 702 plus the offset multiplied by common size 704. In one example, slot indexes for various commands 282 are written to doorbell register 284 by computing addresses for each slot index using different offsets.

In some embodiments, configuring doorbell register 700 to use offsets n permits combining multiple slot indexes into a single transaction layer packet using a PCIe write combine operation. The single TLP can be used if slot indexes are written to contiguous addresses of doorbell register 700.

In one embodiment, a GPU thread selects an offset when issuing a command. For example, the offset 708 is selected between 0 and N−1. N is the number of slot indexes (e.g., each having a size of 4B) that fit in doorbell register 700. The thread writes the slot index in the doorbell register 700 at an address computed using that selected offset.

Various approaches can be used to select the offset value for each thread. In one approach, the selection of the offset value is a pseudo random between 0 and N−1. In one approach, the offset value is computed as a modulo of a GPU thread number. For example, the offset value is computed as (GPU thread number) modulo N. In one approach, the offset value is computed as an atomic variable increment (using one variable per slot index) modulo N. By using different offsets for slot indexes to be written to doorbell register 700, the probability of being able to combine multiple slot indexes into a single TLP is increased.

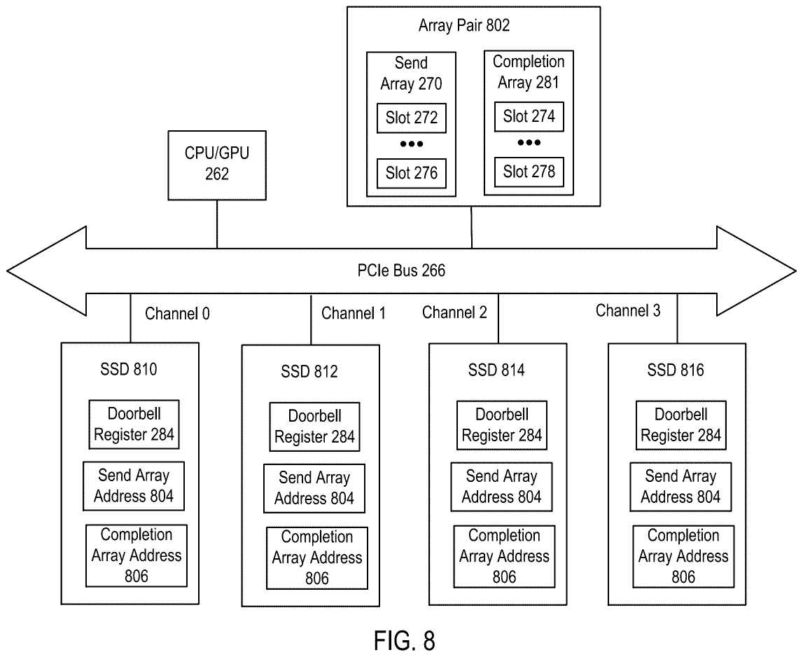

FIG. 8 shows multiple solid-state drives that share an array pair 802 according to one embodiment. CPU/GPU 262 allocate a portion of host memory for array pair 802. Array pair 802 includes send array 270 and completion array 281.

Array pair 802 is shared by multiple SSDs 810, 812, 814, 816. CPU/GPU 262 sends send array address 804 and completion array address 806 to each SSD to establish channels 0, 1, 2, 3 between the SSDs and array pair 802. CPU/GPU 262 also causes creation of a doorbell register 284 by each SSD. The doorbell register 284 is associated with array pair 802.

In one example, commands are written in slots 272, 276 by a thread running on CPU/GPU 262. Slot indexes for the slots 272, 276 are written to one of doorbell registers 284. In one embodiment, each slot index is sent to a doorbell register 284. The doorbell register 284 to which to send the slot index is selected based on the corresponding SSD that will execute the command to read or write a page of data according to a data striping or other data storage scheme implemented by CPU/GPU 262. After the command is executed, a completion record is written by the corresponding SSD to one of slots 274, 278 of completion array 281.

In some embodiments, CPU/GPU 262 can create additional array pairs in addition to array pair 802. The additional array pairs can be allocated to any one or all of SSDs 810, 812, 814, 816. The additional array pairs also can be allocated to other SSDs.

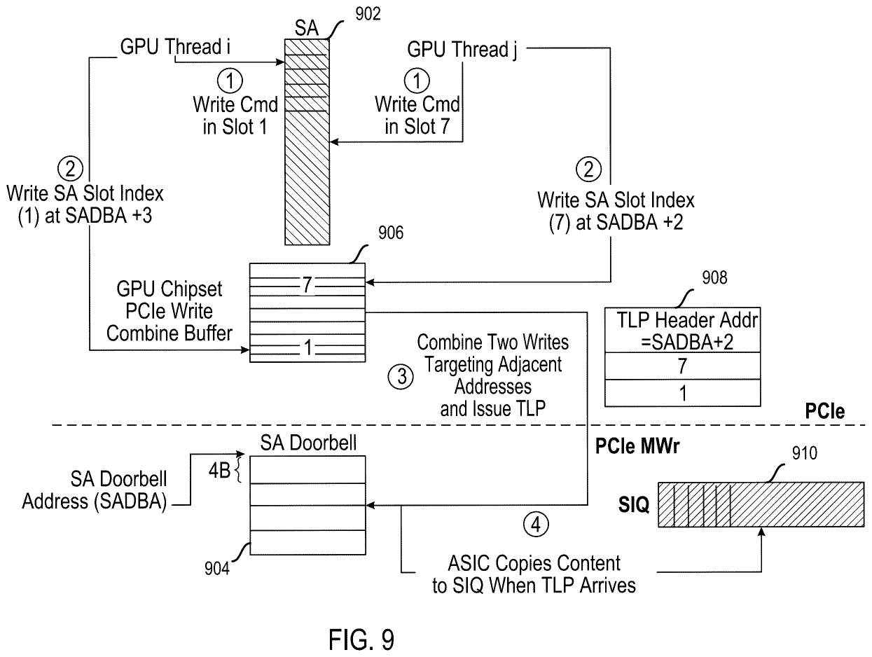

FIG. 9 shows combining of multiple writes of slot indexes into a single transaction layer packet (TLP) according to one embodiment. Various threads running on GPU can write commands into various slots of send array 902. Slot indexes corresponding to the slots into which the commands are written are sent to doorbell register 904 of a memory sub-system 308. The slot indexes are sent to doorbell register 904 using transaction layer packets 908. In some cases, multiple slot indexes are combined in write combine buffer 906 for sending in a single TLP 908.

In one example, as illustrated in step 1, GPU threads i and j write commands in slots 1 and 7 of send array 902. For example, the GPU threads i and j each issue a NVMe command at about the same time and both write at the same time in the SA 902 without contention. Prior to writing the commands to send array 902, thread i is assigned slot index 1 by the GPU, and thread j is assigned slot index 7 by the GPU.

In step 2, threads i and j each write a slot index at the same time in doorbell register 904 of an SSD. Each thread uses a different offset to compute an address in doorbell register 904 to which its slot index is written. For example, thread i writes at offset 3 and thread j writes at offset 2. Each offset increment corresponds to a unit of storage having a size of 4B.

In step 3, a chipset or other hardware of the GPU performs a PCIe write combine operation. While performing this operation, the hardware identifies that the two writes are performed at contiguous addresses. The hardware combines the two writes into single TLP 908 and sends the TLP 908 using a single PCIe MWr.

In step 4, as soon as the TLP 908 arrives at the doorbell register 904, an ASIC of the SSD copies the slot indexes 7 and 1 in slot index queue 910 of the SSD.

In one embodiment, the doorbell register 904 is used to inform the SSD that slots in the SA 902 contain new commands ready to execute. The data written in the doorbell register 904 is slot index[es] (32 bits each index). The writes made to the doorbell register 904 do not need to arrive in order. The SSD ASIC monitors for the arrival of TLPs 908 targeted at the SA doorbell address (SADBA) and immediately stores the slot index data of the TLPs in slot index queue (SIQ) 910.

The minimum size of the doorbell register 904 is 32 bits because each SA 902 slot index is 32 bits in size. However, the efficiency in using PCIe can be improved by reducing the PCIe protocol overhead. This is done by grouping several slot indexes in a same TLP 908. When slot indexes are grouped, doorbell register 904 has a larger size to accommodate the maximum number of slot indexes to be sent in a single TLP 908. A doorbell register 904 that is larger than 32 bits allows the use of the GPU chipset doing the PCIe write combine two groups multiple slot indexes and a TLP 908.

For example, if the doorbell register 904 size is n×32 bits with n>1, the GPU PCIe chipset can combine multiple slot indexes (e.g., combine several slot indexes for writes issued by different GPU threads into one TLP). In one example, doorbell register 904 can hold four slot indexes and has a size of 4×32 bits.

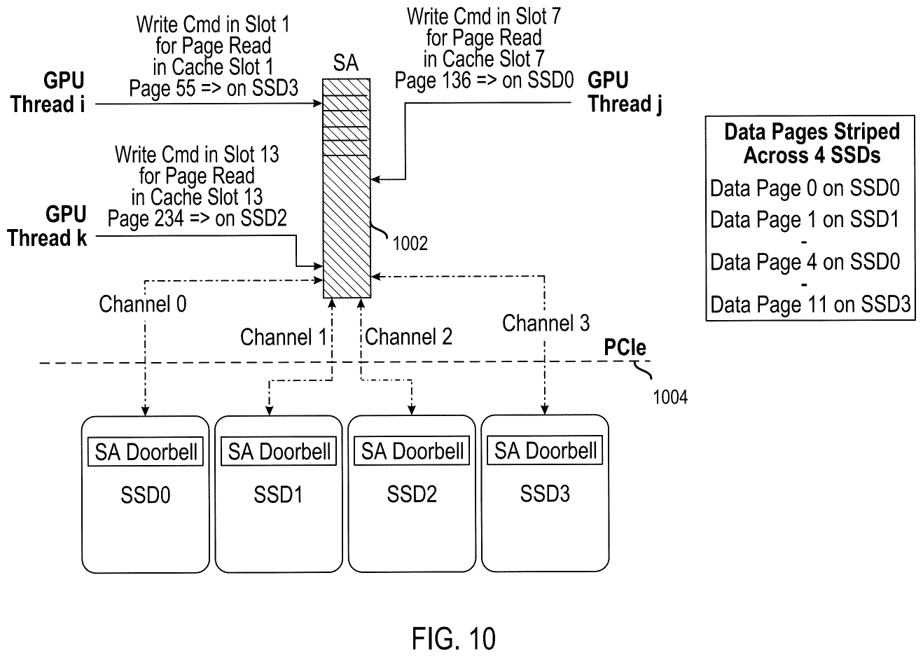

FIG. 10 shows striping of cache pages across multiple solid-state drives according to one embodiment. In one example, the striped data pages are stored in cache 321 or 403. The data pages are striped across multiple SSDs (SSD0, SSD1, SSD2, SSD3). For example, data page 0 is stored on SSD0, data page 1 is stored on SSD1, data page 4 is stored on SSD0, and data page 11 is stored on SSD3.

Various threads are executing on a GPU and write commands to send array 1002. For example, thread i writes a command in slot 1 of send array 1002 for a page read in cache slot 1. Thread j writes a command in slot 7 of send array 1002 for a page read in cache slot 7. Thread k writes a command in slot 13 of send array 1002 for a page read in cache slot 13.

Slot indexes for the commands are written to the doorbell register of the appropriate SSD determined based on the page number to be read and the striping scheme being implemented. For example, page 55 is read from SSD3, page 136 is read from SSD0, page 234 is read from SSD2. Each page is read from a storage space on the appropriate SSD, and the data is transferred over PCIe bus 1004 to the host.

In one example, DMA engine 411 writes the read page of data to a memory address in DRAM of host memory that corresponds to the cache slot that is the target of the page read by the thread.

In one example, data in a cache is striped across several SSDs, or the data is duplicated across several SSDs. In such case, an array pair is shared across the SSDs to reduce the amount of GPU memory that is required.

In one example, GPU configuration software allocates GPU memory for one array pair AP[ ] having one element in the array pair AP[ ] per each cache slot. The software creates 4 AP channels (Channel 0, Channel 1, Channel 2, Channel 3), one with each SSD. The software passes to each SSD the same address of the unique array pair AP[ ] that has been allocated in GPU memory. The software associates 4 doorbell registers, one on each SSD, with the array pair. Thus, all 4 SSDs are given the same address for the send array SA[ ] and the same address for the completion array CA[ ].

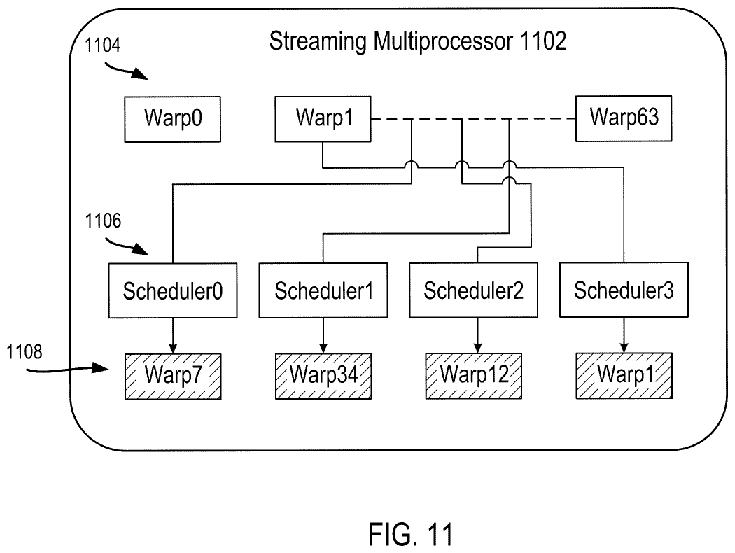

FIG. 11 shows thread scheduling for a streaming multiprocessor 1102 according to one embodiment. Eligible warps 1104 are available for use by streaming multiprocessor (SM) 1102. Schedulers 1106 of SM 1102 can select various warps 1104 for use in processing. Warps 1104 that are selected are referred to as active warps 1108. For example, scheduler 0 selects warp 7 from eligible warps 1104. Warp 7 becomes one of active warps 1108.

Streaming multiprocessor 1102 is a hardware component of a GPU. Streaming multiprocessor 1102 is sometimes referred to as a compute unit. Each SM on a GPU is associated with an array pair. For example, SM 1102 is associated with an array pair allocated in host memory. In one example, SM 1102 can run a maximum of 64 warps at one time. For each warp, there is only one thread that does an IO. The array pair is created to have a size of 64 slots, which corresponds to 64 warps can run simultaneously. In one example, SM 1102 runs a warp to do an IO because of a cache miss.

As an example, GPU code that is performing IOs has only one thread per warp that is handling the IO. The other threads of the warp wait for the data to be obtained (e.g. written to the cache) before consuming it in parallel. Each eligible warp has a context number from 0 to 63. When the warp is re-scheduled, this context number stays the same until the warp's operations are complete.

In one embodiment, an allocation method used by GPU allocates an AP of 64 elements for each SM (e.g., SM 1102). When a thread of a warp performs an IO, the thread uses a slot in the array pair (AP[thread warp context]). The slot index for the slot is selected to be the context number of the warp that includes the thread. Because no other GPU thread can use this same AP element at that time, thread contention is avoided.

In one example, an array pair is allocated for each GPU SM. If several SSDs are used by the GPU, the AP is shared to reduce GPU memory requirements. The number of threads that SM 1102 can concurrently handle is 2048 (2048 threads is 64 warps of 32 threads each). Thus, an allocation of an AP per SM having a size of 2048 slots is sufficient.

In some cases, the GPU code (kernel) enforces only one reader per warp (e.g., as done in GIDS feature aggregation). This results in a maximum of 64 threads (one per warp) that can have an IO inflight for a given SM. Thus, in this case it is sufficient to allocate an AP with 64 slots per SM. The SA and CA of the allocated array pair have a number of slots equal to the maximum number of 64 thread warps in parallel.

In one embodiment, the scheduling for streaming multiprocessor 1102 is done at a warp granularity (32 threads). SM 1102 is assigned a number of thread blocks each composed of a number of thread warps (32 threads). Any threads run by SM 1102 are run in these thread blocks.

Initially, for example, 64 warps from various thread blocks are selected by the SM 1102 to become eligible warps 1104. Then, each SM scheduler (e.g., of a total 4 schedulers available in the GPU) selects one warp among the eligible warps 1104 and runs it. The selected warp is now considered to be in an active state and is one of active warps 1108.

When a warp blocks (e.g., after a memory load instruction has been initiated and a cache miss occurred), the scheduler that selected the warp changes the state of the warp to inactive and replaces the inactive warp with another eligible thread (that becomes active).

Once an eligible warp completes its operations (after having been scheduled a number of times), it is no longer eligible. Another new warp is fetched from a thread block assigned to SM 1102. The new warp replaces the no longer eligible warp. The new warp is now considered to be an eligible warp. In one example, if a GPU thread is in the process of doing an IO, then it is a thread of an eligible warp.

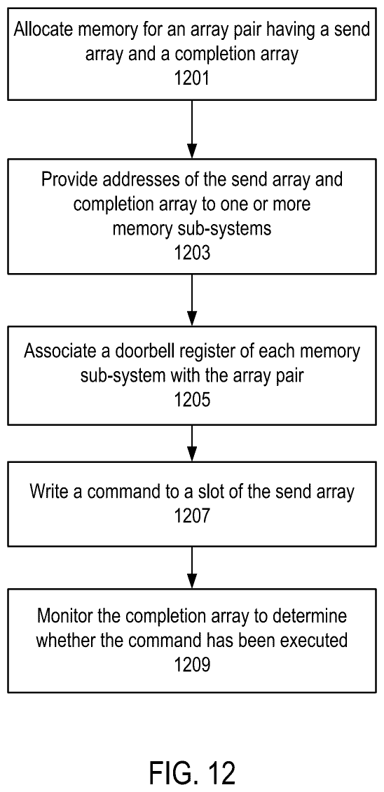

FIG. 12 shows a method for associating an array pair with one or more memory sub-systems according to one embodiment. The method of FIG. 12 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 12 is performed at least in part by the processing device 118 of the host system 102, the controller 115 of the memory sub-system 101, and/or the local media controller 105 of the memory sub-system 101 in FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 12 can be implemented using the array pair manager 113 of FIG. 1 to perform the operations illustrated in FIGS. 2-11.

At block 1201 in FIG. 12, host memory is allocated for an array pair that includes a send array and a completion array. Slots of the send array uniquely correspond one-to-one with slots of the completion array. In one example, the array pair is formed using send array 270 and completion array 281.

At block 1203, addresses of the send array and completion array are provided to one or more memory sub-systems. In one example, send array address 804 and completion array address 806 are provided to each of multiple SSDs that share array pair 802.

At block 1205, a doorbell register of each memory sub-system is associated with the array pair. In one example, doorbell register 284 is associated with send array 405. In one example, index 256 is written to doorbell register 284.

At block 1207, a command is written by a thread to a slot of the send array. In one example, thread 450 writes a command to slot 272 of send array 270.

At block 1209, the completion array is monitored to determine whether the command has been executed. In one example, slot 274 of completion array 281 is monitored to determine whether the command written to uniquely corresponding slot 272 has been executed.

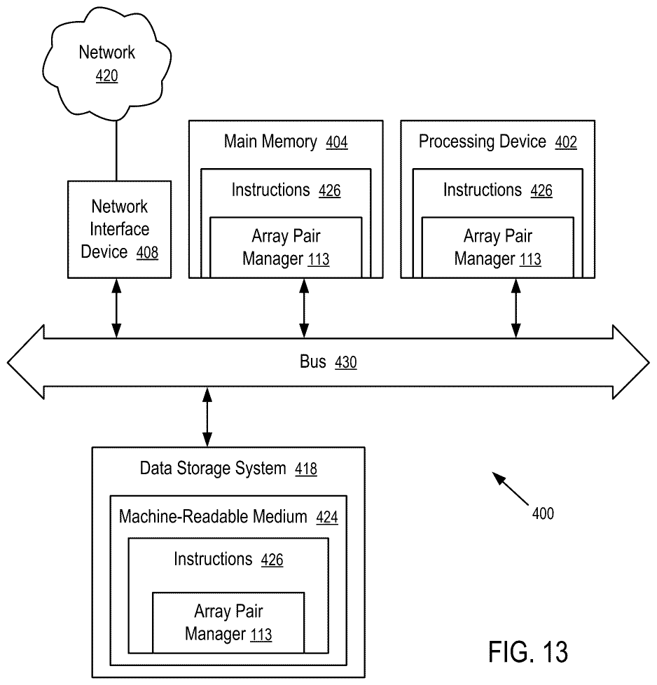

FIG. 13 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of array pair manager 113 (e.g., to execute instructions to perform operations corresponding to the array pair manager 113 described with reference to FIGS. 1-12). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

In one example, instructions 426 are executed to configure processing of commands. In one example, instructions 426 are executed to configure firmware and/or hardware circuitry.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the array pair manager 113 described with reference to FIGS. 1-12. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system comprising:
non-volatile memory; and
a controller configured to:
retrieve a command from a send array having locations that can be accessed randomly, wherein the command is retrieved using an index that identifies a location in the send array, and the command is configured to cause the controller to transfer data between a memory location identified via the command and the non-volatile memory; and
execute the command to transfer the data.

2. The memory sub-system of claim 1, wherein the controller is further configured to:
in response to completing execution of the command, write a completion record to a slot of a completion array, wherein the slot corresponds to the index.

3. The memory sub-system of claim 2, wherein the send array and the completion array are associated as an array pair.

4. The memory sub-system of claim 1, further comprising local memory, wherein the controller is further configured to receive the index from a host system in the local memory, and retrieve the command from the send array in response to receiving the index.

5. The memory sub-system of claim 4, wherein the local memory is a doorbell register, and the index is received in the doorbell register as one of a plurality of slot indexes from the host system.

6. The memory sub-system of claim 1, wherein the controller is further configured to copy the index to a queue in response to receiving the index from a host system.

7. The memory sub-system of claim 1, wherein the memory location is in random-access memory of a host system.

8. The memory sub-system of claim 1, wherein the data is transferred to the memory location identified via the command from a first storage location in a storage space identified via a logical block addressing (LBA) address provided in the command.

9. The memory sub-system of claim 8, wherein the LBA address identifies a block in a logical storage space partitioned into a plurality of logical blocks of a common size.

10. The memory sub-system of claim 8, wherein the first storage location is further identified via a namespace identifier specified in the command in accordance with an NVMe standard.

11. The memory sub-system of claim 1, wherein the controller is further configured to retrieve a plurality of commands from the send array, each command retrieved using an index that corresponds to one of a plurality of slots in the send array.

12. The memory sub-system of claim 11, wherein each of the plurality of commands has a predetermined length of 512 bits.

13. A host system comprising:
memory; and
at least one processing device configured to:
run a thread to write a command to a first slot of a send array having a plurality of slots that can be accessed randomly, wherein the first slot is selected using an index of the send array that corresponds to the thread, and the thread writes the command to read data from or write data to a memory sub-system; and
monitor a completion array located in the memory to determine whether the command has been executed by the memory sub-system, wherein the completion array is associated with the send array, and a completion record is written to a slot of the completion array selected by the memory sub-system using the index.

14. The host system of claim 13, wherein each of the plurality of slots of the send array is assigned to a respective one of a plurality of threads running on a graphics processing unit (GPU) of a host system.

15. The host system of claim 13, wherein the processing device is further configured to assign the index to the thread.

16. The host system of claim 13, wherein the processing device is further configured to write the index to a doorbell register of the memory sub-system.

17. The host system of claim 16, wherein:
the processing device is further configured to select an offset; and
the offset determines a location in the doorbell register to which the index is written.

18. The host system of claim 13, wherein the processing device is further configured to monitor the completion array and determine a completion of execution of the command based on a change in state of a phase bit in the completion record.

19. The host system of claim 13, wherein the send array is located in memory of the host system or memory of the memory sub-system.

20. The host system of claim 13, wherein:
the processing device is further configured to execute software that manages a memory cache having a plurality of slots, each slot storing a page of data;
the command is configured to cause the memory sub-system to transfer data between a first slot of the memory cache and non-volatile memory of the memory sub-system; and
the first slot of the memory cache is identified by the memory sub-system using the index.

21. The host system of claim 13, wherein:
the processing device is a graphics processing unit (GPU);
the send array and the completion array are allocated to a streaming multiprocessor of the GPU; and
the streaming multiprocessor handles the thread.

22. A host system comprising:
memory; and
at least one processing device configured to:
allocate a portion of the memory for an array pair comprising a send array having randomly-accessible slots associated with corresponding slots in a completion array;
provide an address of the send array and an address of the completion array to each of a plurality of memory sub-systems; and
associate a respective doorbell register of each memory sub-system with the array pair.

23. The host system of claim 22, wherein the processing device is further configured to write a first index in a first doorbell register of a first memory sub-system, and the first index identifies the corresponding slots in the send array and the completion array.

24. The host system of claim 22, wherein the memory comprises a cache having slots of a common size, each slot stores user data, and each slot corresponds to a respective one of the corresponding slots in the send array and completion array.

25. The host system of claim 24, wherein each slot of the cache is identified by a respective index, and the corresponding slots in the send array and completion array are identified by the same index.

26. The host system of claim 22, wherein the memory comprises a cache having slots, each slot to store a page of data read from or written to non-volatile memory of one of the memory sub-systems, and the processing device is further configured to:
write a first index of a first slot of the cache to a first doorbell register of a first memory sub-system; and
write a second index of a second slot of the cache to a second doorbell register of a second memory sub-system.
